(19) United States
(12) Patent Application Publication
(10) Pub. No.: US 2012/0249798 A1
(43) Pub. Date: Oct. 4, 2012

(54) RTLS TAG DEVICE AND REAL TIME LOCATION SYSTEM

(75) Inventor: Bum Youl KIM, Anyang (KR)

(73) Assignee: LSIS CO., LTD., Anyang-si (KR)

(21) Appl. No.: 13/425,308

(22) Filed: Mar. 20, 2012

(30) Foreign Application Priority Data
Apr. 4, 2011 (KR) 10-2011-0030895

(51) Int. Cl. H04N 7/18; G08B 1/08

(52) U.S. Cl. 348/159; 340/539.13; 348/E07.085

(57) ABSTRACT

Provided, according to the present invention, is an RTLS tag device generating a power through a shock applied to a piezoelectric element and transmitting tag information or an emergency signal to the wireless LAN APs, and a real time location system including an integrated management server receiving the tag information through the wireless LAN APs to extract location information of the RTLS tag device and providing the extracted location information to a client, and transmitting an alarm signal to the client, if it is determined that the emergency signal has been received or the location information deviates from a predetermined scope.

### CROSS-REFERENCE TO RELATED APPLICATION

Pursuant to 35 U.S.C. §119 (a), this application claims the benefit of earlier filing date and right of priority to Korean Patent Application No. 10-2011-0030895 filed on Apr. 4, 2011, the contents of which is hereby incorporated by reference in their entirety.

### BACKGROUND OF THE INVENTION

1. Field of the Invention

The present invention relates to an RTLS (Real Time Location System) tag device and an RTLS (Real Time Location System), and more particularly, to an RTLS tag device configured to track a position of a mobile object and an RTLS.

2. Description of the Related Art

RTLS (Real-time locating systems) are a type of local positioning system that allows tracking and identifying the location of objects in real time. Using simple, inexpensive badges or tags attached to the objects by way of such communication technologies as Wi-Fi, ZigBee, UWB, RFID and Bluetooth, readers receive wireless signals from these tags to determine their locations. Realtime location system (RTLS) mainly includes a plurality of methods for calculating distances and positions according to characters of wireless signals. For example, the RTLS includes the angle of arrival (AOA) method, the time of arrival (TOA) method, the time difference of arrival (TDOA) method, the triangulation method and the received signal strength (RSS) method.

The RTLS serves in operational areas for logistics and other services, as for example stock grounds or storehouses, and for servicing areas in clinics and industrial plants. Tasks done by an RTLS include, for example, to combine identity and location of any type of items or objects, to combine identity of items with location of lifter placing the items, to ensure permanent availability of proper information about temporary placement, to support notification of placing of items, to prove proper manning of operational areas, to prove consequent evacuation of endangered areas, and to make marshalling staff dispensable.

The RTLS has a plurality of tag devices. Each tag device has a unique identification code. Each tag device will transmit a location signal when activated. A plurality of location receivers are installed in a fixed location. The location receivers will receive the location signal and calculate a location of the tag device transmitting the location signal. A signal mechanism is coupled to an I/O port of each tag device. The location mechanism provides at least one of an audible signal or visual signal when activated. A location reader is provided. The location reader receives the location data transmitted by the plurality of location receivers to enable a person to locate the tag device transmitting the location signal.

In case of measuring a position of a mobile object using the RTLS, a fixed object is required that may be a base for position determination, and a wireless LAN (Local Area Network) AP (Access Point) may be used as the base for the position determination.

Although an accurate position tracking may be possible by densely installing the wireless LAN APs that serve as base for position determination, the densely installation of the wireless LAN APs is disadvantageous in terms of cost, installation and management sides, such that it is problematic to accurately determine positions in a wide outdoor space using the RTLS. Another problem in the RTLS tag device is that a battery must be periodically charged or replaced because the RTLS tag device is generally supplied with a driving power using the battery.

### SUMMARY OF THE INVENTION

Accordingly, the present invention is directed to an RTLS tag device and a real time location system configured to solve the abovementioned problems, and therefore it is an object to provide an RTLS tag device configured to enable an accurate position tracking using an RTLS or a GPS (Global Positioning System) depending on a place the RTLS tag device is located, and to generate a tag driving power according to movement of an object by installing a piezoelectric element to the RTLS tag device, and a real time location system using the same.

Additional advantages, aspects, and features of the invention will be set forth in part in the description which follows and in part will become apparent to those having ordinary skill in the art upon examination of the following or may be learned from practice of the invention.

In one general aspect of the present invention, there is provided an RTLS tag device for measuring a location of a mobile object, the device comprising: a Wi-Fi module unit communicating with a wireless LAN AP; a GPS module unit receiving GPS information from GPS satellites; a main power unit generating a driving power through a piezoelectric element generating an electric energy when applied with a pressure; and a controller collecting tag information and transmitting the tag information to the Wi-Fi module unit by selectively and controllably operating the Wi-Fi module unit or the GPS module unit in response to an SSID (Service Set Identification) included in a signal received from the wireless LAN AP.

Preferably, but not necessarily, the tag information includes at least any one of RSSI (Received Signal Strength Indicator), a received time information of a signal received from the wireless LAN AP and GPS information.

Preferably, but not necessarily, the controller operatively controls the Wi-Fi module unit, if it is determined that the RTLS tag device is located indoors in response to the SSID (Service Set Identification), and operatively controls the GPS module unit, if it is determined that the RTLS tag device is located outdoors in response to the SSID (Service Set Identification).

Preferably, but not necessarily, the RTLS tag device further comprises an acceleration sensor detecting a velocity change of the mobile object, and the controller, if it is determined that the velocity change of the mobile object detected by the acceleration sensor has surpassed a predetermined reference value, determines that the occurrence is an emergency event, and transmits an emergency signal to the Wi-Fi module unit.

Preferably, but not necessarily, the RTLS tag device further comprises an input unit formed with an emergency button configured to manipulate the occurrence of emergency, and the controller determines that there has occurred emergency, if it is determined that the emergency button of the input unit has been manipulated, and transmits the emergency signal to the Wi-Fi module unit.

Preferably, but not necessarily, the RTLS tag device further comprises an auxiliary battery, and the controller controls supply of a driving power using the auxiliary battery if the emergency event occurs.

In another general aspect of the present invention, there is provided a real time location system tracking a location of a mobile object, the system comprising: a plurality of wireless LAN APs; an RTLS tag device generating a power through a shock applied to a piezoelectric element and transmitting tag information or an emergency signal to the wireless LAN APs; and an integrated management server receiving the tag information through the wireless LAN APs to extract location information of the RTLS tag device and providing the extracted location information to a client, and transmitting an alarm signal to the client, if it is determined that the emergency signal has been received or the location information deviates from a predetermined scope.

Preferably, but not necessarily, the RTLS tag device includes: a Wi-Fi module unit communicating with a wireless LAN AP; a GPS module unit receiving GPS information from GPS satellites; a main power unit generating a driving power through a piezoelectric element generating an electric energy when applied with a pressure; and a controller collecting tag information and transmitting the tag information to the Wi-Fi module unit by selectively and controllably operating the Wi-Fi module unit or the GPS module unit in response to an SSID (Service Set Identification) included in a signal received from the wireless LAN AP.

Preferably, but not necessarily, the tag information includes at least any one of RSSIs (Received Signal Strength Indicators), a received time information of a signal received from the wireless LAN AP and GPS information.

Preferably, but not necessarily, the controller operatively controls the Wi-Fi module unit, if it is determined that the RTLS tag device is located indoors in response to the SSID (Service Set Identification), and operatively controls the GPS module unit, if it is determined that the RTLS tag device is located outdoors in response to the SSID (Service Set Identification).

Preferably, but not necessarily, the system further comprises an acceleration sensor detecting a velocity change of mobile object, and the controller, if it is determined that the velocity change of the mobile object detected by the acceleration sensor has surpassed a predetermined reference value, determines that the occurrence is an emergency event, and transmits an emergency signal to the Wi-Fi module unit.

Preferably, but not necessarily, the system further comprises an input unit formed with an emergency button configured to manipulate the occurrence of emergency, and the controller determines that there has occurred emergency, if it is determined that the emergency button of the input unit has been manipulated, and transmits the emergency signal to the Wi-Fi module unit.

Preferably, but not necessarily, the system further comprises an auxiliary battery, and the controller controls supply of a driving power through the auxiliary battery if the emergency event occurs.

Preferably, but not necessarily, the system further comprises a plurality of network cameras, and the integrated management server further includes an image information DB (Database) storing an image captured by the network camera.

Preferably, but not necessarily, the integrated management server includes an RTLS server extracting location information of the RTLS tag device from the tag information or the GPS information, and a network camera server receiving an image from the network camera and providing an image of a network camera adjacent to the location information of a relevant RTLS tag device if an image request signal is received from outside.

The RTLS tag device and the RTLS according to the present invention has an advantageous effect in that the RTLS tag device is formed with a Wi-Fi module unit and a GPS module unit to enable an accurate location tracking under indoor and outdoor environments, and a driving power is supplied using a piezoelectric element to eliminate inconveniences of periodically replacing or charging a battery by separating the RTLS tag device from an object.

### BRIEF DESCRIPTION OF THE DRAWINGS

The accompanying drawings, which are included to provide a further understanding of the invention and incorporated in and constitute a part of this application, illustrate exemplary embodiment(s) of the invention and together with the description serve to explain the principle of the invention. In the drawings:

FIG. 1 is a schematic block diagram illustrating an RTLS tag device according to an exemplary embodiment of the present invention;

FIG. 2 is a schematic block diagram illustrating a real time position system according to an exemplary embodiment of the present invention; and

FIG. 3 is a flowchart explaining a location tracking process according to an exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings. The invention may, however, be embodied in many different forms and should not be construed as being limited to the embodiments set forth herein. Rather, these embodiments are provided so that this disclosure will be thorough and complete, and will fully convey the concept of the invention to those skilled in the art. Wherever possible, the same reference numerals will be used throughout the drawings to refer to the same or like parts.

As used herein, the terms “a” and “an” herein do not denote a limitation of quantity, but rather denote the presence of at least one of the referenced item. That is, as used herein, the singular forms “a”, “an” and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Also, “exemplary” is merely meant to mean an example, rather than the best. If is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated.

The term “access point” (AP), and the like are utilized interchangeably in the subject specification and drawings and refer to a wireless network component or apparatus that sends and/or receives data associated with voice, video, sound, and/or substantially any data-stream or signaling-stream between a set of subscriber stations—unless context warrants particular distinction(s) among the terms.

Furthermore, the described features, advantages, and characteristics of the invention may be combined in any suitable manner in one or more embodiments. One skilled in the relevant art will recognize that the invention may be practiced without one or more of the specific features or advantages of a particular embodiment.

Those of skill will recognize that the various illustrative logical blocks, modules, circuits, and units described in connection with the embodiments disclosed herein may be implemented as electronic hardware, computer software or combinations of both.

As used herein, the term of ‘position’ and ‘location’ may be interchangeably used. As used herein, the term of ‘correlation’ and ‘correlation value’ may be interchangeably used.

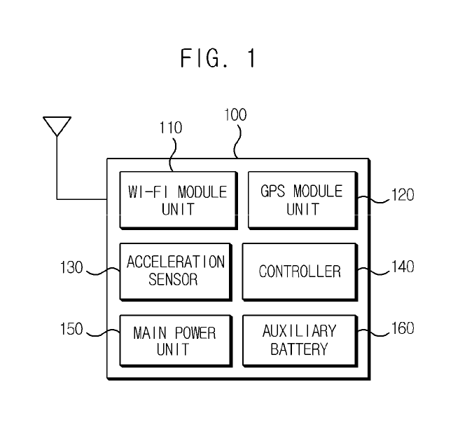

FIG. 1 is a schematic block diagram illustrating an RTLS tag device according to an exemplary embodiment of the present invention.

Referring to FIG. 1, an RTLS tag device 100 according to an exemplary embodiment of the present invention includes a Wi-Fi module unit 110, a GPS module unit 120, an acceleration sensor 130, a controller 140, a main power unit 150 and an auxiliary battery 160.

The Wi-Fi module unit 110 collects tag information by communicating with a wireless LAN access point (hereinafter referred to as WLAN AP). The Wi-Fi module unit 110 scans an adjacent WLAN AP, receives a signal including an SSID (Service Set Identification) that is an intrinsic identification information of the WLAN AP, and transmits the signal to the controller 140. Furthermore, the Wi-Fi module unit 110 receives the tag information from the controller 140 and transmits the tag information to the WLAN AP, where the tag information may include the SSID and RSSI (Received Signal Strength Indicator) corresponding to the SSID. The tag information may include time information on time of signal received from the WLAN AP, GPS information and ID of RTLS tag device. The WLAN AP functions to receive the tag information and transmit the tag information to an RTLS engine configured to calculate location information.

The GPS module unit 120 receives GPS information corresponding to the location information of the RTLS tag device 100 from GPS satellites. The GPS module unit 120 is operated in response to control by the controller 140, where the RTLS tag device 100 is operated to receive the GPS information when located outdoors. The GPS module unit 120 transmits the GPS information to the controller 140, where the controller 140 transmits the tag information including the GPS information to the Wi-Fi module unit 110.

The acceleration sensor 130 detects a velocity change of an object attached with the RTLS tag device. The acceleration sensor 130 provides a detection signal based on the velocity change of the object to the controller 140, whereby determination can be made as to whether the object moves with a sudden velocity change different from that of normal times.

The controller 140 determines whether the object attached with the RTLS tag device is located indoors or outdoors based on the SSID included in the signal received by the Wi-Fi module unit 110 from adjacent WLAN AP, and controls the Wi-Fi module unit 110 or the GPS module unit 120 to selectively operate.

As a result of the determination, if the object is located outdoors, the controller 140 controls in such a manner that the GPS module unit 120 is operated. The GPS module unit 120 receives GPS information corresponding to the location information of the object from the GPS satellites, and transmits the GPS information to the controller 140.

As a result of the determination, if the object is located indoors, the controller 140 controls in such a manner that the Wi-Fi module unit 110 is operated to collect the RSSI information received from the WLAN AP and signal reception time information. The controller 140 transmits the tag information including the GPS information, the RSSI information, the signal reception time information to the Wi-Fi module unit 110, where the tag information is transmitted to a server formed with a location tracking engine for calculating the location information of the object via the WLAN AP. The Wi-Fi module unit 110 periodically receives signal from the WLAN AP, and the controller 140 collects the tag information at every period and transmits the tag information to the server formed with the location tracking engine, whereby the location information of the object can be continuously recognized.

Furthermore, the controller 140 generates an emergency signal, in a case an emergency event occurs and transmits the emergency signal to the server via the Wi-Fi module unit 110. The emergency event may correspond to a case the velocity change of the object detected by the acceleration sensor 130 surpasses a predetermined reference value, or a user manipulates an emergency button through a user input unit (not shown) that may be installed at the RTLS tag device 100. The predetermined reference value relative to the velocity change may be differently set up depending on the object. For example, if the object is a child moving on a road, the reference value can be set up from a running velocity of the child, and if a child is kidnapped and moved on a vehicle of a kidnapper, the controller 140 determines that there has occurred an emergency event, because a velocity change detected by the acceleration sensor 130 surpasses the predetermined value.

The main power unit 150 and the auxiliary battery 160 serve to supply a driving power to the RTLS tag device 100. The main power unit 150 may include a plurality of piezoelectric elements generating an electric energy if pressure is applied, and convert the electric energy generated by the piezoelectric elements to a DC voltage to charge the battery. The auxiliary battery 160 may supply a power, in a case an insufficient energy is generated by the main power unit 150 or the emergency event develops. Whether to supply a power using the auxiliary battery 160 is determined by the controller 140, where the controller 140 may control the power supply of the auxiliary battery 16 by determining the power suppliable by the main power unit 150, and whether the emergency event has occurred.

The RTLS tag device 100 thus configured according to the present invention may be installed on a mobile object, and hereinafter, an exemplary embodiment will be explained where the RTLS tag device 100 is mounted on a child that needs a proper protection by continuously checking a moving location. A child can be properly protected, in a case a crime with the child as a target occurs, by installing the RTLS tag device 100 on the child and tracking and monitoring a child location.

In a case a crime with a child as a target occurs, the RTLS tag device 100 may be installed on an inner sole of a child's shoes lest an attacker acknowledge that the RTLS tag device 100 is installed.

In a case the RTLS tag device 100 is installed on the inner sole of the child's shoe, and the child moves with the shoes on (that is, walks or runs), a pressure is continuously applied to the piezoelectric elements included in the main power unit 150, whereby an electric energy generated by the piezoelectric elements is used to generate a driving power for the RTLS tag device 100.

Preferably, the RTLS tag device 100 maintains a sleep mode state during normal times to minimize the power consumption, and the RTLS tag device 100 is operated only during occurrence of emergency event.

For example, in a case a child of location tracking object is moving, a timer event is generated under a sleep mode state after lapse of a predetermined time, or an emergency event occurs, it is preferred that the RTLS tag device 100 be so set as to be converted from the sleep mode state. Meanwhile, in a case a power generated by the main power unit 150 is not sufficient enough to drive the RTLS tag device 100, the sleep mode state is maintained to allow the battery to be charged. However, even in this case, a driving power is supplied by the auxiliary battery 160 to activate the RTLS tag device 100, if the emergency event occurs.

In a case the RTLS tag device 100 is diverted from the sleep mode state due to occurrence of emergency event, the Wi-Fi module unit 110 scans an ambient WLAN AP, receives a signal and collects SSID. The controller 140 uses the SSID to determine whether the child mounted with the RTLS tag device 100 is located indoors or outdoors. As a result of determination, if the child mounted with the RTLS tag device 100 is located indoors, the controller 140 collects RSSI information of a signal received from the WLAN AP, an SSID of relevant WLAN AP and signal reception time information, and in a case the child mounted with the RTLS tag device 100 is located outdoors, the controller 140 receives GPS information from the GPS module unit 120.

The controller 140 transmits the tag information including the RSSI information, the SSID of relevant WLAN AP, the GPS information and the signal reception time information to a server installed with a location tracking engine via the WLAN AP through the Wi-Fi module unit 110, and the child's location information calculated by the server is provided to clients including parents and relevant authorities.

Meanwhile, in a case a crime such as kidnap or abduction occurs, and the child manipulates the emergency button, the controller 140 generates an emergency signal and transmits the signal to the server through the Wi-Fi module unit 110. Furthermore, even in a case a change in moving velocity of the child surpasses a predetermined reference value detected by the acceleration sensor 130 mounted on the RTLS tag device 100, the controller 140 determines that an emergency event has occurred, generates an emergency signal and provides the signal to the server.

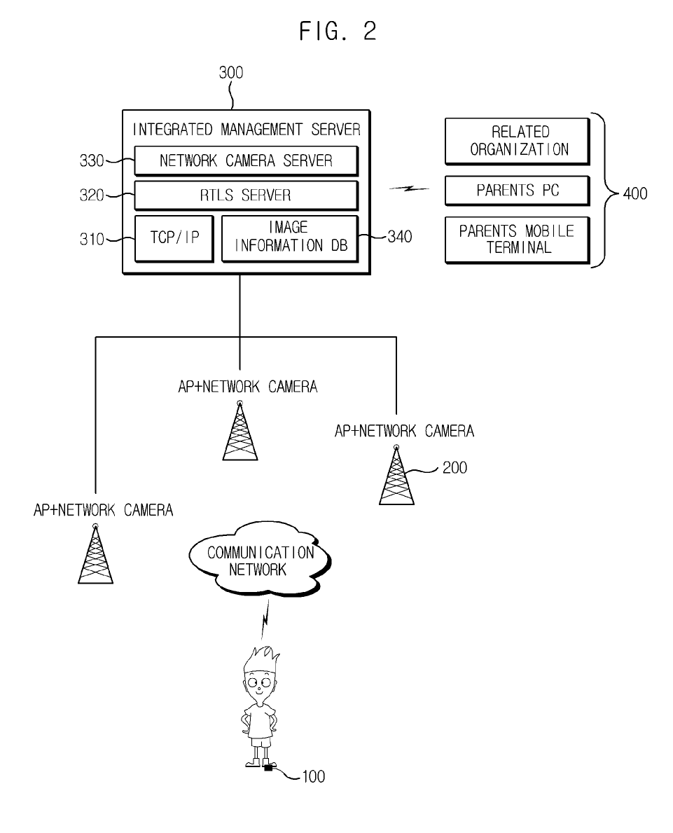

FIG. 2 is a schematic block diagram illustrating a real time position system according to an exemplary embodiment of the present invention.

Referring to FIG. 2, a real time location system tracking a location of a mobile object includes an RTLS tag device 100, a plurality of WLAN APs 200 and an integrated management server 300.

The RTLS tag device 100 is mounted on a position tracking object, and has the same configuration as that of RTLS tag device 100 described in FIG. 1. The WLAN AP 200 performs a communication with the Wi-Fi module unit 110 of the RTLS tag device 100, and transmits tag information received from the RTLS tag device 100 and an emergency signal to the integrated management server 300.

The WLAN AP 200 may be mounted with a network camera. The network camera captures an ambient image and the captured ambient image is transmitted to the integrated management server 300 where the captured ambient image is periodically stored. Furthermore, in a case an image request signal is received from a client, an image about an object may be photographed based on location information of the RTLS tag device 100, and provided to the client in real time.

The integrated management server 300 may include a TCP/IP interface 310, an RTLS server 320, a network camera server 330 and an image information database 340.

The TCP/IP interface 310 is configured to perform a data communication with the WLAN AP 200. Although FIG. 2 has exemplified a case where the WLAN AP 200 performs a data communication with the integrated management server 300 according to TCP/IP protocol, the configuration is not limited thereto. It should be apparent to the skilled in the art that the case may be realized with a wired or wireless network capable of performing a data communication.

The RTLS server 320 may include an RTLS engine using tag information provided from the RTLS tag device 100 to calculate location information and a map database (not shown). The RTLS server 320 serves to analyze the tag information to extract location information of the RTLS tag device 100, to prepare a location coordinate, to make a database of the location coordinate and to display the location coordinate on a map. The RTLS engine uses position tracking algorithms such as fingerprinting, triangulation method, ToA (Time of Arrival) and TDoA (Time Difference of Arrival) to calculate location information of an object.

Meanwhile, the RTLS server 320 extracts the location information, in a case the RTLS tag device 100 is located outdoors to allow GPS information to be received as the tag information, where the GPS information is used to enable a performance of an accurate location indoors and outdoors.

The network camera server 330 receives an image photographed by the network camera and controllably and periodically stores the photographed image in the image information database 340. Meanwhile, in a case an image request signal is received from an outside client, an image of an ambient network camera can be provide in real time based on location information of the RTLS tag device corresponding to a tag ID included in the image request signal.

The integrated management server 300 extracts location information of an object and provides the location information to a client. Furthermore, the integrated management server 300 transmits an alarm signal to the client in a case an emergency signal is received from the RTLS tag device 100, or the location information of the object deviates from a predetermined scope. The client is a principal requesting the location information of an object to be location-tracked, monitoring the object and coping with the emergency event. FIG. 2 illustrates a child as an object, and the relevant authority, PC of a parent and mobile terminal 400 of the parents may be the client. The alarm signal may be provided in real time in the form of a text message and/or an image of the network camera.

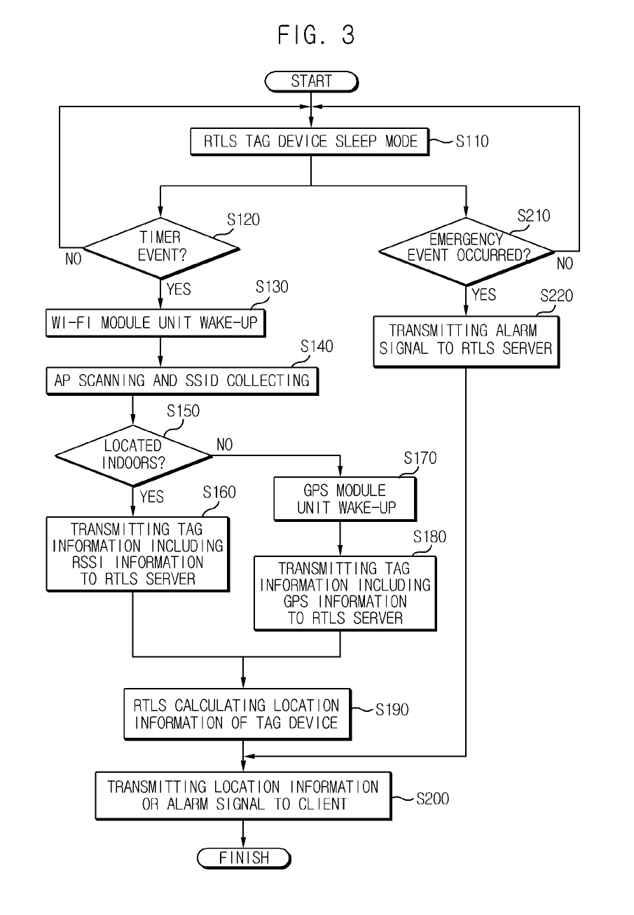

FIG. 3 is a flowchart explaining a location tracking process according to an exemplary embodiment of the present invention.

An RTLS tag device according to the present invention maintains a sleep mode state, S110 during normal times for minimizing power consumption after a power is turned on. The RTLS tag device under the sleep mode state is woken up in a case a special event occurs and activated. In a case a timer event is developed due to lapse of a predetermined time from the sleep mode state, the Wi-Fi module unit 110 is changed to a wake-up mode and activated, S120, S130.

The Wi-Fi module unit 110 scans an ambient WLAN AP, receives a signal and collects SSID of the ambient WLAN AP, S140. The controller 140 uses the SSID to determine whether the RTLS tag device 100 is located indoors or outdoors, S150. As a result of determination, if the RTLS tag device 100 is located indoors, the controller 140 transmits tag information including RSSI information of a signal received from the WLAN AP, an SSID of relevant WLAN AP and signal reception time information to the Wi-Fi module unit 110. The Wi-Fi module unit 110 provides the tag information to the RTLS server 320 mounted at the integrated management server 300, S160.

As a result of the determination at S150, if the RTLS tag device 100 is located outdoors, the controller 140 controls in such a manner that the GPS module unit 120 is woken up and activated, S170. The GPS module unit 120 receives GPS information corresponding to location information of the RTLS tag device 100 from GPS satellites. The controller 140 transmits the tag information including the GPS information to the Wi-Fi module unit 110, where the tag information is transmitted to the RTLS server 320 of the integrated management server 300 via the WLAN AP, S180. The RTLS server 320 uses the RSSI information included in the tag information, the SSID of relevant wireless LAN AP, the signal reception time information and the GSP information to calculate and extract the location information of the RTLS tag device 100, S190.

Meanwhile, in a case an emergency event, i.e., an event waking up the RTLS tag device100, is developed S210, the controller 140 generates an alarm signal and transmits the alarm signal to the RTLS server 320 of the integrated management server 300, S220. The emergency event is developed when a user manipulates an emergency button mounted at the RTLS tag device 100, or a velocity change detected by the acceleration sensor 130 surpasses a predetermined reference value.

The RTLS server 320 provides the location information of the RTLS tag device 100 calculated at S190 to the client periodically or in real time, S200. Furthermore, the RTLS server 320 immediately transmits the alarm signal received at S220 to a PC or a mobile terminal of the client, whereby the client can properly cope with the emergency event that is developed from the location tracking object.

As apparent from the foregoing, the RTLS tag device and the RTLS according to the present invention have an industrial applicability in that the RTLS tag device is formed with a Wi-Fi module unit and a GPS module unit to enable an accurate location tracking under indoor and outdoor environments, and a driving power is supplied using a piezoelectric element to eliminate inconveniences of periodically replacing or charging a battery by separating the RTLS tag device from an object.

It will be apparent to those skilled in the art that various modifications and variations can be made in the present invention. Thus, it is intended that the present invention covers such modifications and variations of the invention. The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. An RTLS tag device for measuring a location of a mobile object, the device comprising:
a Wi-Fi module unit communicating with a wireless LAN AP;
a GPS module unit receiving GPS information from GPS satellites;
a main power unit generating a driving power through a piezoelectric element generating an electric energy when applied with a pressure; and
a controller collecting tag information and transmitting the tag information to the Wi-Fi module unit by selectively and controllably operating the Wi-Fi module unit or the GPS module unit in response to an SSID (Service Set Identification) included in a signal received from the wireless LAN AP.

2. The device of claim 1, wherein the tag information includes at least any one of RSSI (Received Signal Strength Indicator), a received time information of a signal received from the wireless LAN AP and GPS information.

3. The device of claim 1, wherein the controller operatively controls the Wi-Fi module unit, if it is determined that the RTLS tag device is located indoors in response to the SSID (Service Set Identification), and operatively controls the GPS module unit, if it is determined that the RTLS tag device is located outdoors in response to the SSID (Service Set Identification).

4. The device of claim 1, further comprising an acceleration sensor detecting a velocity change of the mobile object, wherein the controller, if it is determined that the velocity change of the mobile object detected by the acceleration sensor has surpassed a predetermined reference value, determines that the occurrence is an emergency event, and transmits an emergency signal to the Wi-Fi module unit.

5. The device of claim 1, further comprising an input unit formed with an emergency button configured to manipulate the occurrence of emergency, wherein the controller determines that there has occurred emergency, if it is determined that the emergency button of the input unit has been manipulated, and transmits the emergency signal to the Wi-Fi module unit.

6. The device of claim 4, further comprising an auxiliary battery, wherein the controller controls supply of a driving power through the auxiliary battery if the emergency event occurs.

7. The device of claim 5, further comprising an auxiliary battery, wherein the controller controls supply of a driving power through the auxiliary battery if the emergency event occurs.

8. A real time location system tracking a location of a mobile object, the system comprising:
a plurality of wireless LAN APs;
an RTLS tag device generating a power through a pressure applied to a piezoelectric element and transmitting tag information or an emergency signal to the wireless LAN APs; and
an integrated management server receiving the tag information through the wireless LAN APs to extract location information of the RTLS tag device and providing the extracted location information to a client, and transmitting an alarm signal to the client, if it is determined that the emergency signal has been received or the location information deviates from a predetermined scope.

9. The system of claim 8, wherein the RTLS tag device includes: a Wi-Fi module unit communicating with a wireless LAN AP; a GPS module unit receiving GPS information from GPS satellites; a main power unit generating a driving power through a piezoelectric element generating an electric energy when applied with a pressure; and a controller collecting tag information and transmitting the tag information to the Wi-Fi module unit by selectively and controllably operating the Wi-Fi module unit or the GPS module unit in response to an SSID (Service Set Identification) included in a signal received from the wireless LAN AP.

10. The system of claim 9, wherein the tag information includes at least any one of RSSIs (Received Signal Strength Indicators), a received time information of a signal received from the wireless LAN AP and GPS information.

11. The system of claim 9, wherein the controller operatively controls the Wi-Fi module unit, if it is determined that the RTLS tag device is located indoors in response to the SSID (Service Set Identification), and operatively controls the GPS module unit, if it is determined that the RTLS tag device is located outdoors in response to the SSID (Service Set Identification).

12. The system of claim 9, further comprising an acceleration sensor detecting a velocity change of the mobile object, wherein the controller, if it is determined that the velocity change of the mobile object detected by the acceleration sensor has surpassed a predetermined reference value, determines that the occurrence is an emergency event, and transmits an emergency signal to the Wi-Fi module unit.

13. The system of claim 9, further comprising an input unit formed with an emergency button configured to manipulate the occurrence of emergency, and the controller determines that there has occurred emergency, if it is determined that the emergency button of the input unit has been manipulated, and transmits the emergency signal to the Wi-Fi module unit.

14. The system of claim 12, further comprising an auxiliary battery, and the controller controls supply of a driving power through the auxiliary battery if the emergency event occurs.

15. The system of claim 13, further comprising an auxiliary battery, and the controller controls supply of a driving power through the auxiliary battery if the emergency event occurs.

16. The system of claim 8, further comprising a plurality of network cameras, and the integrated management server further includes an image information DB (Database) storing an image captured by the network camera.

17. The system of claim 16, wherein the integrated management server includes an RTLS server extracting location information of the RTLS tag device from the tag information or the GPS information, and a network camera server receiving an image from the network camera and providing an image of a network camera adjacent to the location information of a relevant RTLS tag device if an image request signal is received from outside.
